(19) United States
(12) Patent Application Publication
(10) Pub. No.: US 2011/0261089 A1
(43) Pub. Date: Oct. 27, 2011

(54) DISPLAY APPARATUS

(75) Inventor: Kohji OHNISHI, Kobe-shi (JP)

(73) Assignee: FUJITSU TEN LIMITED, KOBE-SHI (JP)

(21) Appl. No.: 13/080,204

(22) Filed: Apr. 5, 2011

(30) Foreign Application Priority Data
Apr. 27, 2010 (JP) 2010-101783

(51) Int. Cl. G09G 5/10

(52) U.S. Cl. 345/690

(57) ABSTRACT

A display apparatus that displays an image includes a display that has a screen displaying an image used for navigation by a car navigation system, the image having a first area having an own-vehicle position mark and a second area having a selection mark for receiving an operation intended for implementing a prescribed function, a backlight that has a plurality of light sources lighting the screen, and a controller that controls the backlight so as to light an area excluding both the first area and the second area on the image with a brightness lower than a brightness of the first area.

### BACKGROUND OF THE INVENTION

1. Field of the Invention

The invention relates to a technology for displaying images on a screen.

2. Description of the Background Art

Recently, energy-saving technologies have been emphasized in view of environmental affair. Display apparatuses adopting the energy-saving technologies, such as a TV set, a mobile terminal, a car navigation apparatus, attract much attention.

One of the energy-saving technologies adopted by these display apparatuses reduces significantly current consumption by controlling a backlight effectively. Japanese Patent Application Laid open Publication No. 2009-251331 discloses one example of the display apparatuses. The display apparatus that has a plurality of LEDs included in a backlight corresponding to an image to be displayed displays an image, having the LEDs on in accordance with the luminance of the image to be displayed, and having some of the LEDs off corresponding to an area displayed in relatively low luminance.

However, when a display apparatus adopting such an energy-saving technology displays an image used for navigation by a car navigation system (hereinafter, referred to as a car navigation image) where images having less low-luminance areas are used, since the display apparatus controls its backlight at a certain level of brightness, current consumption can not be reduced.

### SUMMARY OF THE INVENTION

According to one aspect of the invention, a display apparatus that displays an image includes a display that has a screen displaying an image used for navigation by a car navigation system, the image having a first area having an own-vehicle position mark and a second area having a selection mark for receiving an operation intended for implementing a prescribed function, a backlight that has a plurality of light sources lighting the screen, and a controller that controls the backlight so as to light an area excluding both the first area and the second area on the image with a brightness lower than a brightness of the first area.

Since the display apparatus controls the plurality of light sources included in the backlight so as to light the area excluding both the first area and the second area on the image with the brightness lower than the brightness of the first area, current consumption can be reduced while the car navigation function is fulfilled.

According to another aspect of the invention, the plurality of light sources of the backlight are disposed in a vicinity of one edge of the screen. The controller included in the display apparatus individually controls an amount of light emitted from each of the plurality of light sources.

Since the display apparatus individually controls the amount of light emitted from each of the plurality of light sources in the backlight, the area excluding both the first area and the second area can be lighted in the brightness lower than the brightness of the first area, and current consumption can be reduced while car navigation function is fulfilled.

According to another aspect of the invention, the second area of the display apparatus is a U-shaped area in contact with the one edge of the screen and two other edges that are substantially perpendicular to the one edge of the screen.

Since the second area is the U-shaped area in contact with the one edge of the screen and two other edges that are substantially perpendicular to the one edge of the screen, the amount of light in the area excluding both the U-shaped area and the first area can be reduced, and current consumption can be reduced while the car navigation function is fulfilled.

Therefore, the object of the invention is to reduce current consumption of a backlight included in a display apparatus.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 is a figure showing a display.

FIG. 2 is a system configuration diagram of an on-vehicle apparatus.

FIG. 3 is a figure showing an image.

FIG. 4 is a figure showing another image.

FIG. 5 is a figure showing a display image and a backlight state.

FIG. 6 is a flowchart showing controls implemented by the on-vehicle apparatus.

FIG. 7 is a figure showing another display image and another backlight state.

FIG. 8 is a figure showing another display image and another backlight state.

FIG. 9 is a figure showing another display.

FIG. 10 is a figure showing another display.

### DESCRIPTION OF THE EMBODIMENTS

The technology described below applies to various display apparatuses equipped with a display. However, for the sake of convenience, only the on-vehicle apparatus having a car navigation system function is described concretely. Here are separate descriptions with reference to attached drawings, of a configuration of a display included in the on-vehicle apparatus, a configuration of the on-vehicle apparatus, and controls implemented by the on-vehicle apparatus.

### Representative Embodiment

### Configuration of Display of On-Vehicle Apparatus

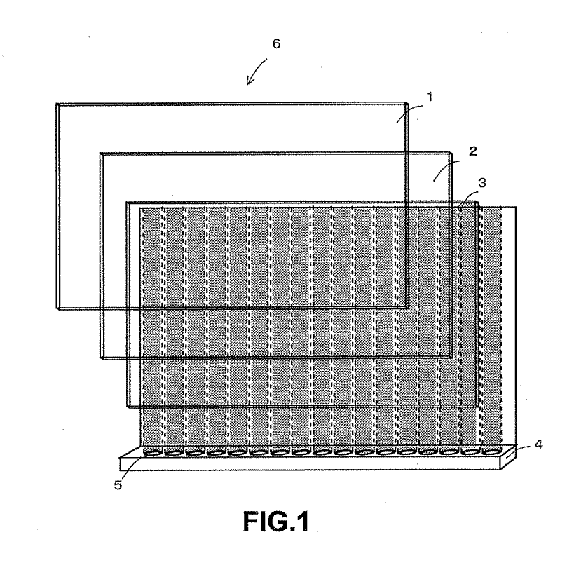

The configuration of the display included in the on-vehicle apparatus installed in a vehicle is described based on FIG. 1. A display 6 includes a color filter 1, a liquid crystal layer 2, TFT (Thin Film Transistor) 3, and a backlight 4.

The color filter 1 is a film on which three primary colors (RGB) are printed on each pixel.

The liquid crystal layer 2 has a shutter function in which the light of the backlight 4 installed at the back is transmitted when the molecular arrangements of the liquid crystal layer 2 are changed based on an applied external voltage.

The TFT 3 is a thin film transistor that includes electrodes disposed in a matrix. When an image controller controls electrical current flowing into those electrodes, a voltage generated in cells disposed in a matrix on the TFT 3 changes the molecular arrangements of liquid crystal based on the cells in the liquid crystal layer 2.

That is, the TFT 3 has a function of displaying a color that the image controller desires using the light of the backlight 4 transmitted through to the front side of the color filter 1.

The backlight 4 includes a plurality of LEDs 5 (Light Emitting Diodes) disposed in series to be used as light sources.

A screen of the display 6 includes the color filter 1, the liquid crystal layer 2 and the TFT 3. The screen of the display 6 is lighted by the backlight 4.

The backlight 4 is an edge light type in a simple structure, which is the most appropriate structure for an on-vehicle apparatus that requires a thinner display in structure, i.e. downsizing. The backlight 4 of the edge light type includes the plurality of LEDs 5 to be used as light sources, which are disposed in series near the base line (bottom base) of the display 6 in a rectangular shape. On the display 6, the farther and the closer to an opposite side of the base line (upper base) the light travels, the weaker the light becomes. To avoid this issue, the display 6 includes a polarizer that functions to spread light evenly on the backlight 4.

The backlight 4 controls the LEDs 5 included in the backlight 4 for being on or off simply. The backlight 4 also controls the amount of light of each of the LEDs 5 by providing control current in different duty proportions to each of the LEDs 5.

As above, the display 6 includes the color filter 1, the liquid crystal layer 2, the TFT 3 and the backlight 4 in layers. The TFT 3 and the backlight 4 of the display 6 are controlled by an image controller that is an LSI of the on-vehicle apparatus, and the display 6 displays images used for a car navigation system (i.e. car navigation images), digital TV images, etc. on the screen of the display 6.

<Configuration of On-Vehicle Apparatus>

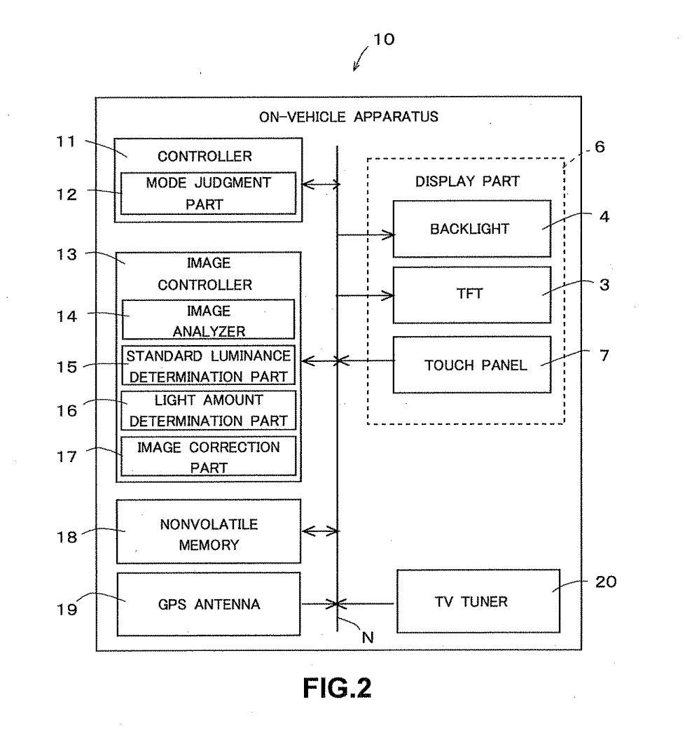

Next, the configuration of an on-vehicle apparatus is described based on FIG. 2. An on-vehicle apparatus 10 includes a controller 11, an image controller 13, a nonvolatile memory 18, a GPS antenna 19, a TV tuner 20 and the display 6, which are connected electrically to a bus N supporting data communication.

The controller 11 is a microcomputer that includes a CPU and a ROM storing control programs and the like. In an example, a mode judgment part 12 included in the controller 11 has a mode judgment function. The function is to judge whether or not a touch panel 7 included in the display 6 receives an operation intended to switch a power saving mode (i.e. eco mode) on from a user regarding the on-vehicle apparatus 10. Details of the mode judgment function are described later.

The image controller 13 is, for example, an LSI (Large Scale Integration). In an example, each of an image analyzer 14, a standard luminance determination part 15, a light amount determination part 16 and an image correction part 17 that are included in the image controller 13, has a function of image analyzing, standard luminance determination, light amount determination and image correction.

The image analyzer 14 has a function of analyzing an image to be displayed on the display 6. The standard luminance determination part 15 has a function of determining standard luminance of an image to be input. The image correction part 17 has a function of correcting an image based on standard luminance and its amount of light. The light amount determination part 16 has a function of determining the amount of light to be emitted from the backlight 4. The functions of the image analyzing, the standard luminance determination, the light amount determination and the image correction are described in particular later.

The image controller 13 also has a function of displaying an image on the screen of the display 6 by controlling the TFT 3, and a function of lighting the screen of the display 6 by controlling the backlight 4.

The nonvolatile memory 18 is a flash memory such as EEPROM, and stores data relating to car navigation images and other data. The data relating to car navigation images are map images, an own-vehicle position mark and a direction mark, for example.

The GPS antenna 19 is an antenna for receiving from GPS satellites GPS data that indicates where the vehicle equipped with the on-vehicle apparatus 10 is on the earth.

The TV tuner 20 has a function of demodulating the received data of digital TV broadcasting into prescribed data.

The display 6 includes the backlight 4 and the TFT 3 as described above. The display 6 also includes the touch panel 7 that receives a user operation on its screen.

<Control by On-Vehicle Apparatus>

Next, the control implemented by the on-vehicle apparatus is described.

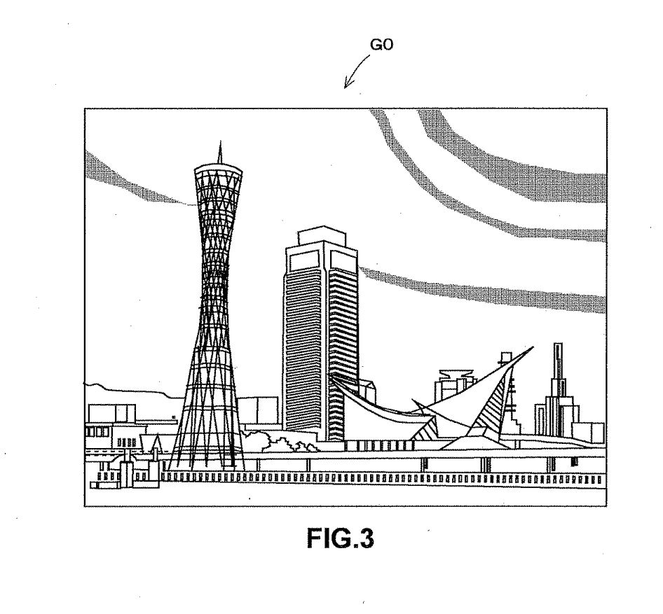

The image controller 13 of the on-vehicle apparatus 10 functions to display on the display 6 a TV image G0 as shown in FIG. 3 received via the TV tuner 20 after receiving a user operation intended for turning on a TV mode via the touch panel 7 of the display 6.

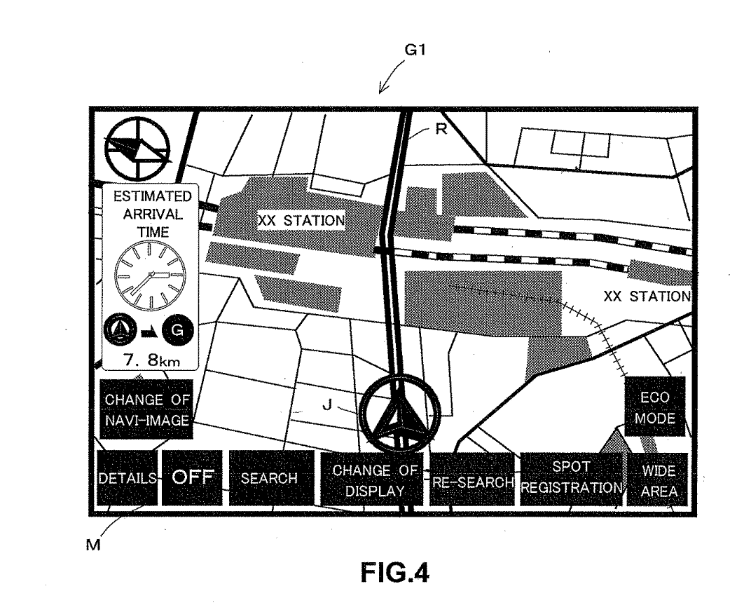

The image controller 13 of the on-vehicle apparatus 10 also functions to display on the display 6 a car navigation image G1 as shown in FIG. 4 after receiving a user operation intended for turning on a car navigation mode via the touch panel 7 of the display 6. The car navigation image G1 includes an own-vehicle position mark J, a plurality of selection marks M for receiving operations intended for implementing prescribed functions, and map images, which are read out from the nonvolatile memory 18 based on the GPS data received via the GPS antenna 19.

The image controller 13 of the on-vehicle apparatus 10 also functions to display a menu screen showing selection marks for a TV mode, a car navigation mode and the like on the display 6, so that a user can select an intended mode or other setting.

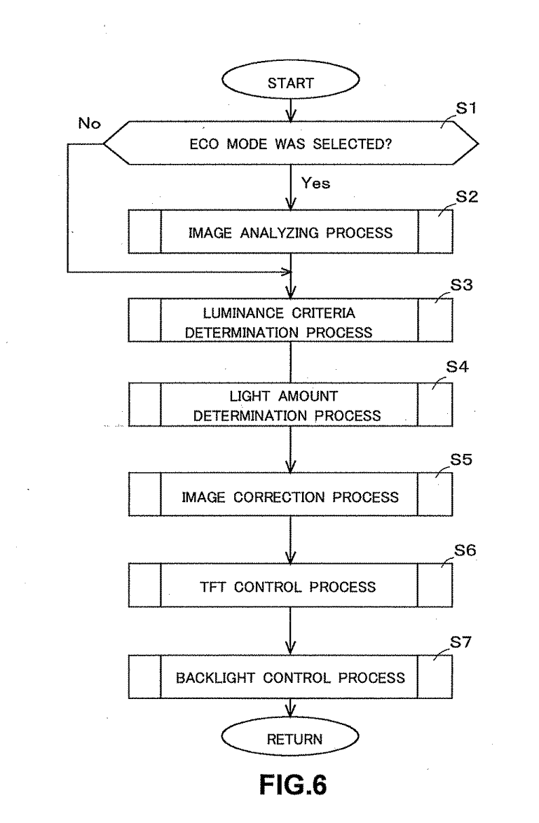

Further, the image controller 13 of the on-vehicle apparatus 10 provides an eco mode consuming lower power on the menu screen and the car navigation image G1, so that a user can select the eco mode. The image controller 13, in the case where a user does not select the eco mode (No at step S1 regarding controls in FIG. 6 described below), implements a normal control where all of the LEDs 5 included in the backlight 4 are on.

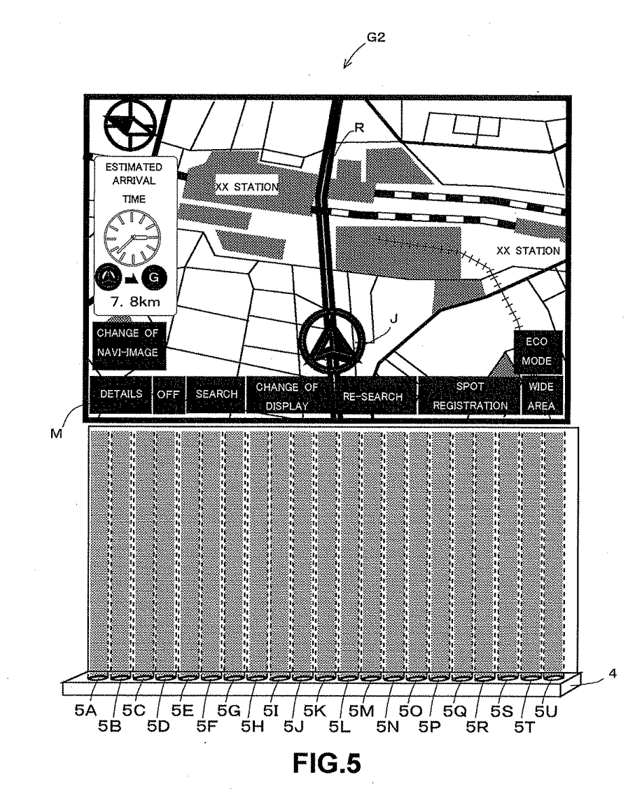

Here, for explanatory purpose, addresses are allocated to the respective 21 units of LEDs 5 in such a manner as 5A is for the first left as a LED 5A, 5B for the second left as a LED 5B, 5C for the third left as a LED 5C, etc., as in FIG. 5.

The on-vehicle apparatus 10 implements the controls shown in FIG. 6 prior to displaying a car navigation image G2 at the beginning or at the time of update unless a user turns off the power of the on-vehicle apparatus 10, or selects other functions such as TV display.

The image controller 13 updates the display at the times when an own-vehicle position obtained via the GPS antenna 19 moves by a prescribed distance or more and when vehicle speed obtained via a vehicle-velocity sensor installed in the vehicle changes over by a prescribed amount or more, and at other occasions.

Hereafter, the controls implemented by the on-vehicle apparatus 10 are described based on the flowchart shown in FIG. 6.

In the step S1, the mode judgment part 12 judges whether or not a user selected the eco mode via the touch panel 7 included in the display 6. When the mode judgment part 12 judges that a user selected the eco mode (Yes at the step S1), the process moves to step S2. When the mode judgment part 12 does not judge that a user selected the eco mode (No at the step S1), the process moves to step S3.

The description of the processes for display after the process moved to the step S3 in the case of No at the step S1 is omitted here because the processes are the same as conventional processes.

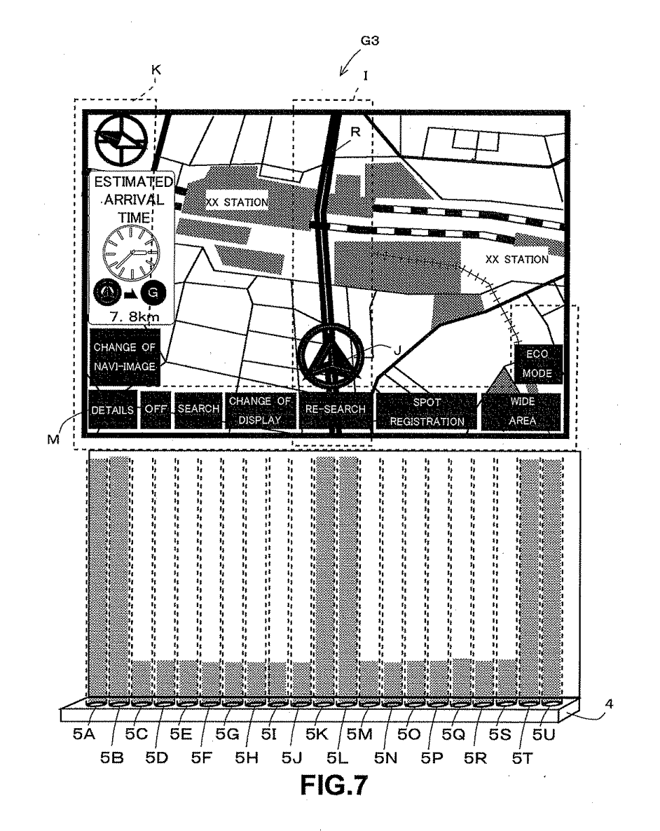

In the step S2, the image analyzer 14 determines the locations of the own-vehicle position mark J and a line R indicating a route to a destination on a car navigation image G3. Then, the image analyzer 14 defines a first area I centered on the own-vehicle position mark J and the line R as in FIG. 7. The car navigation image G3 shown in FIG. 7 is displayed having its traveling direction always looking up, i.e. in a head-up display system, on the screen of the display 6.

The image analyzer 14 also defines a second area K centered on the selection marks M that are included in the car navigation image G3 and have functions of receiving operations intended for implementing prescribed functions, as in FIG. 7.

The second area K is a U-shaped area in contact with one edge and two other edges that are substantially perpendicular to the one edge of the rectangular screen of the display 6. This one edge is the base side (bottom base) of the screen of the display 6. The base side is near the line of the plurality of LEDs 5 disposed in series in the backlight 4 of an edge light type included in the display 6. Next, the process moves to step S3.

In the step S3, the standard luminance determination part 15 derives an average of luminance (hereinafter, referred to as average luminance) of pixels on the input car navigation image G3. Next, the process moves to step S4.

In the step S4, the light amount determination part 16 determines amounts of light of the plurality of LEDs 5 included in the backlight 4, the amounts of light corresponding to the first area I and the second area K on the car navigation image G3.

That is, the light amount determination part 16 determines the amount of light of an area as a predetermined proportion (e.g. 100%) in which the LED 5A, the LED 5B, the LED 5K, the LED 5L, the LED 5T and the LED 5U light, the area corresponding to the first area I and a part of the second area K on the car navigation image G3. The light amount determination part 16 also determines the amount of light of another part as a predetermined proportion (e.g. 20%) in which the LEDs 5 from the LED 5C to the LED 5J, and from the LED 5M to the LED 5S light, the another area corresponding to another part of the second area K on the car navigation image G3.

The light amount determination part 16 changes respective proportions of the amounts of light emitted from the LEDs 5 from the LED 5A to the LED 5U based on the numbers or the sizes of the selection marks M indicated in the U-shaped area of the second area K. Next, the process moves to step S5.

In the step S5, the image correction part 17 adjusts (corrects) luminance of an image based on the average luminance derived by the standard luminance determination part 15. That is, the image correction part 17 implements correction regarding all the pixels on the car navigation image G3 in such a manner as when luminance is lower than the average luminance, the luminance is increased by a prescribed proportion (%) in accordance with the differential of luminance, and when luminance is higher than the average luminance, the luminance is decreased by a prescribed proportion (%) in accordance with the differential of luminance (hereafter, this correction is referred to as average luminance correction).

The average luminance correction on an image as above gives a viewer a comfortable impression as a whole by brightening too-dark parts and darkening too-bright parts based on the average luminance. As a result, the image becomes eye-friendly for a viewer.

Further, the image correction part 17 corrects luminance of a third area where the light amount determination part 16 determines that less amount of light is adopted, the third area excluding the first area I and the second area K, by increasing the luminance by a prescribed proportion (%), so that the image shows no uneven brightness as a whole based on the luminance and the amount of light on the image. Next, the process moves to step S6.

In the step S6, the image controller 13 controls the TFT 3 for displaying the car navigation image G3 corrected by the image correction part 17 on the display 6. Here, the image controller 13 controls the TFT 3 so that the display 6 displays the car navigation image G3 by transmitting light of the backlight 4 through one of the three primary colors (RGB) printed on each pixel on the color filter 1. Next, the process moves to step S7.

In the step S7, the image controller 13 controls the plurality of LEDs 5 included in the backlight 4 based on the amounts of light determined by the light amount determination part 16. Here, the image controller 13 controls the LED 5A and the LED 5B, the LED 5K and the LED 5L, and the LED 5T and the LED 5U to be on at a predetermined proportion (e.g. 100%) of the amount of light corresponding to the first area I and a part of the second area K on the car navigation image G3. The image controller 13 also controls the LEDs 5 from the LED 5C to the LED 5J, and from the LED 5M to the LED 5S to be on at a predetermined proportion (e.g. 20%) of the amount of light corresponding to another part of the second area K on the car navigation image G3. Next, the process moves to step Return.

As above, the amount of light of the third area on the car navigation image G3 is smaller than that of the first area I centered on the own-vehicle position mark J and the second area K centered on the selection mark M. The third area excludes both the first area I and the second area K. Thus, the on-vehicle apparatus 10 succeeds in reducing current consumption regarding the car navigation image G3, while fulfilling the car navigation function.

The plurality of LEDs 5 included in the backlight 4 of an edge light type, the LEDs 5 being controlled by the image controller 13, emit light substantially-linearly. That is, the image controller 13 controls the LEDs 5 so as to emit light substantially-linearly from one edge of the screen of the display 6 to the opposite side (facing side), the one edge being near the line on which the plurality of LEDs 5 included in the backlight 4 are disposed in series.

Thus, the image controller 13 is capable of controlling the amount of light emitted from the backlight 4, so that the amount of light in the vicinity in contact with the one edge of the screen is larger and the amount of light in the vicinity of the opposite edge is smaller. However, the image controller 13 is not capable of controlling oppositely the amount of light emitted from the backlight 4, so that the amount of light near the one edge is smaller and the amount of light near the opposite edge is larger.

According to the above, since the second area K is a U-shaped area in contact with the one edge of the screen of the display 6 and two other edges that are substantially perpendicular to the one edge of the screen, the image controller 13 is capable of controlling the amount of light emitted from the backlight 4 of an edge light type, so that the amount of light in the second area K is larger and the amount of light in the third area is smaller.

As a result, on the car navigation image G3, relatively-important indication marks of the own-vehicle position mark J, the line R, and the selection mark M are shown brightly for sure, and relatively-less-important map part other than those marks is shown darker than the above marks. This reduces current consumption, while fulfilling the car navigation function.

Although each of the LEDs 5 included in the backlight 4 of an edge light type actually emits light in a fan form, FIG. 7 indicates the light substantially-linearly after abstracting only the part of stronger light emitted from the LEDs 5. Accordingly, when the LEDs 5 corresponding to the first area I and the second area K are on, the weaker part of the light originally intended to light the first area I and the second area K lights also the third area. Thus, a user can view the map part of the third area. It is because the third area is not completely dark.

### MODIFICATION

So far, the representative embodiment of the invention was described. The invention is not to be considered limited to the described embodiment above, but includes various modifications. The sections hereafter describe some modifications. Aspects of each embodiment described above and below can be arbitrarily combined with each other.

### Modification 1

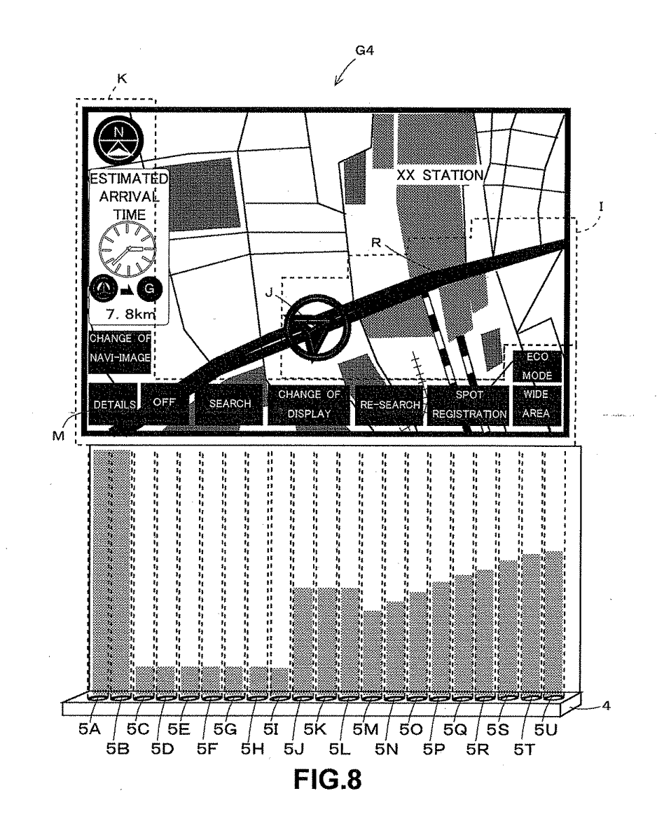

In the above representative embodiment, it was described that the car navigation image G3 in FIG. 7 is a car navigation image of a head-up display system. However, a car navigation image G4 on the display 6 may be displayed in North-up style where an image includes a map image having its North up as in FIG. 8.

The area opposite to the driving direction indicated by the own-vehicle position mark J on the line R indicating a route to a destination may be displayed darker because the importance of the opposite area is relatively low. Thus, in the case where a user sets a display mode, the image controller 13 may control the backlight 4 so that the brightness in the area opposite to the driving direction indicated by the own-vehicle position mark J in the first area I becomes darker than that in the area where the own-vehicle position mark J is pointing.

Such configuration of the on-vehicle apparatus 10 makes it possible to reduce current consumption, while fulfilling the car navigation function.

### Modification 2

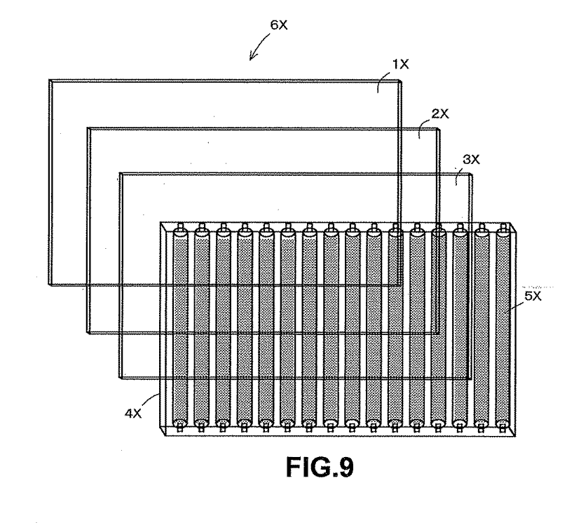

In the above representative embodiment, it was described that the backlight 4 of the display 6 is a light source including the plurality of LEDs (Light Emitting Diodes) disposed in series and is an edge light type where the plurality of LEDs are disposed in series on one edge of the display 6 in a rectangular shape. However, a backlight may include a plurality of fluorescent lights 5X disposed at the reverse side (i.e. back side) of the screen of the display 6X, as shown in FIG. 9.

The configuration of the display 6X is described based on FIG. 9. The display 6X includes a color filter 1X, a liquid crystal layer 2X, a TFT 3X, and a backlight 4X.

The color filter 1X is a film on which three primary colors (RGB) are printed on each pixel. The liquid crystal layer 2X is a so-called liquid shutter in which molecular arrangements are changed corresponding to an applied external voltage or other factors. The TFT 3X is a thin film transistor that includes electrodes arranged in a matrix. On the TFT 3X, an image controller 13 controls current flowing into those electrodes to generate a voltage in an intended cell arranged in a matrix. The generated voltage changes molecular arrangements of liquid crystal in the liquid crystal layer 2X corresponding to the cell. In other words, the TFT 3X has a function of displaying an intended color on a screen by making the light emitted from the backlight 4X go through to the side of the color filter 1X.

Here, an image is displayed after the image controller 13 that is an on-vehicle LSI controls the plurality of fluorescent lights 5X arranged in rows by the similar method with LED control described above.

The image controller 13 can control the plurality of fluorescent lights 5X included in the backlight 4X simply only on or off. That is, the image controller 13 can not control one of the fluorescent lights 5X in a cylindrical shape partially brighter or darker. Thus, since it is impossible to form the second area in a letter-U shape described above or the like, the second area here is an I-shaped area.

### Modification 3

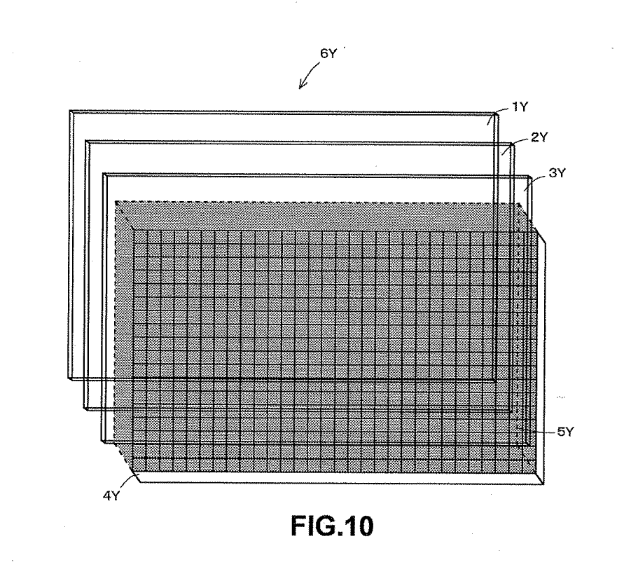

In the above representative embodiment, it was described that the backlight 4 of the display 6 is a light source including the plurality of LEDs disposed in series and is an edge light type where the plurality of LEDs are disposed in series on one side of the display 6 in a rectangular shape. However, a backlight may include a plurality of LEDs arrayed in a matrix and may be installed at the opposite side of the display surface on a display 6Y, as shown in FIG. 10. That is, a backlight of a direct under type which is disposed at the back side.

The configuration of the display 6Y is described based on FIG. 10. The display 6Y includes a color filter 1Y, a liquid crystal layer 2Y, a TFT 3Y, and a backlight 4Y.

The color filter 1Y is a film on which three primary colors (ROB) are printed on each pixel. The liquid crystal layer 2Y is a so-called liquid shutter in which molecular arrangements are changed corresponding to an applied external voltage or other factors. The TFT 3Y is a thin film transistor that includes electrodes arrayed in a matrix. On the TFT 3Y, an image controller 13 controls current flowing into those electrodes to generate a voltage in an intended cell arranged in a matrix. The generated voltage changes molecular arrangements of liquid crystal in the liquid crystal layer 2Y corresponding to the cell. In other words, the TFT 3Y has a function of displaying an intended color on a screen by making the light emitted from the backlight 4Y go through to the side of the color filter 1Y.

Here, an image is displayed after the image controller 13 that is an on-vehicle LSI controls the plurality of LEDs 5Y disposed in a matrix by the similar method with LED control described above.

Further, such configuration is capable of controlling only the cell in a matrix, instead of controlling only the line in the representative embodiment. Thus, it is acceptable to set a circle having a prescribed size centered on the own-vehicle position mark J as the first area described above.

### Modification 4

In the step S3 of the above representative embodiment, the standard luminance determination part 15 derives an average luminance. However, the standard luminance determination part 15 may derive data for a histogram. The data for a histogram are derived by tallying the numbers of pixels in an image by luminance level and are used to form a graph that indicates visually-apparent distribution of pixels by luminance.

In the step S5, the image correction part 17 corrects luminance based on the data of histogram derived by the standard luminance determination part 15 so that the data distribution becomes ideal. That is, the image correction part 17 corrects luminance so that the histogram of pixels by luminance shows that an image is displayed in proper contrast having fine gradation and no defects such as whiteout (clipped highlights) and blackout (clipped shadows). (Hereinafter, this correction is referred to as histogram correction.)

Since the histogram correction on an image brings the distribution of pixels by luminance close to its ideal by brightening too-dark parts and darkening too-bright parts, the image as a whole gives a viewer a comfortable impression, and as a result, the image becomes eye-friendly for a viewer.

### Modification 5

In the above representative embodiment, it was described that the plurality of LEDs 5 included in the backlight 4 of an edge light type included in the display 6 are disposed in series in a line near the base side of the screen of the display 6. However, the line may be near the upper side of the screen.

It was also described that the one edge that the U-shaped area of the second area K contacts is the base side of the screen of the display 6. However, in this case, the one edge may be the upper base of the screen of the display.

### Modification 6

In the above representative embodiment, it was described that the second area K is the U-shaped area in contact with one edge and two other edges that are substantially perpendicular to the one edge of the screen of the display 6. However, the second area K may be an L-shape area in contact with one edge and another edge out of two edges that are substantially perpendicular to the one edge of the screen edges of the display 6. L shape of the L-shaped area is made with one vertical line and one horizontal line running from the bottom end of the vertical line to the right. The L shape also includes the opposite version of the above shape, which is, like seen in a mirror, made with one vertical line and one horizontal line running from the bottom end of the vertical line to the left.

Further, the second area K may be in one straight-belt-shape area in contact with the one edge of the screen of the display 6.

While the invention has been shown and described in detail, the foregoing description is in all aspects illustrative and not restrictive. It is therefore understood that numerous other modifications and variations can be devised without departing from the scope of the invention.

What is claimed is:

1. A display apparatus that displays an image, the display apparatus comprising:
a display that includes a screen displaying an image used for navigation by a car navigation system, the image having a first area having an own-vehicle position mark and a second area having a selection mark for receiving an operation intended for implementing a prescribed function;
a backlight that includes a plurality of light sources lighting the screen; and
a controller that controls the backlight so as to light an area excluding both the first area and the second area on the image with a brightness lower than a brightness of the first area.

2. The display apparatus of claim 1, wherein
the plurality of light sources of the backlight are disposed in a vicinity of one edge of the screen, and
the controller individually controls an amount of light emitted from each of the plurality of light sources.

3. The display apparatus of claim 2, wherein
the second area is a U-shaped area in contact with the one edge of the screen and two other edges that are substantially perpendicular to the one edge of the screen.

4. The display apparatus of claim 2, wherein
the second area is an L-shaped area in contact with the one edge of the screen and one of two other edges that are substantially perpendicular to the one edge of the screen.

5. The display apparatus of claim 1, wherein
the first area further includes a line indicating a route to a destination.

6. The display apparatus of claim 5, wherein
the controller controls the backlight so as to light an area opposite to a driving direction area indicated by the own-vehicle position mark with a brightness lower than a brightness of the driving direction area.

7. A display method for displaying an image, the method comprising the steps of
(a) displaying on a screen an image used for navigation by a car navigation system, the image having a first area having an own-vehicle position mark and a second area having a selection mark for receiving an operation intended for implementing a prescribed function; and
(b) controlling a backlight having a plurality of light sources lighting the screen so as to light an area excluding both the first area and the second area on the image with a brightness lower than a brightness of the first area.

8. The display method of claim 7, wherein
the plurality of light sources of the backlight are disposed in a vicinity of one edge of the screen, and
the step (b) individually controls an amount of light emitted from each of the plurality of light sources.

9. The display method of claim 8, wherein
the second area is a U-shaped area in contact with the one edge of the screen and two other edges that are substantially perpendicular to the one edge of the screen.

10. The display method of claim 8, wherein
the second area is an L-shaped area in contact with the one edge of the screen and one of two other edges that are substantially perpendicular to the one edge of the screen.

11. The display method of claim 7, wherein
the first area further includes a line indicating a route to a destination.

12. The display method of claim 11, wherein
the step (b) controls the backlight so as to light an area opposite to a driving direction area indicated by the own-vehicle position mark with a brightness lower than a brightness of the driving direction area.
